(19) United States
(12) Patent Application Publication
(10) Pub. No.: US 2008/0310171 A1
(43) Pub. Date: Dec. 18, 2008

(54) Optical sheet

(75) Inventors: Masanori Hiraishi, Himeji-shi (JP); Yoshiyuki Nishida, Nagareyama-shi (JP)

Correspondence Address: BIRCH STEWART KOLASCH & BIRCH, PO BOX 747, FALLS CHURCH, VA, 22040-0747, US

(73) Assignee: DAICEL CHEMICAL INDUSTRIES, LTD.

(21) Appl. No.: 12/222,715

(22) Filed: Aug. 14, 2008

(30) Foreign Application Priority Data
Feb. 3, 2006 (JP) 027682/2006

(51) Int. Cl. F21V 5/02

(52) U.S. Cl. 362/339

(57) ABSTRACT

An optical sheet comprises a continuous phase comprising a transparent material and a dispersed phase dispersed in the continuous phase, and has a first surface and a second surface. At least one of the first surface and the second surface forms a prismatic surface of a prism portion constituting portion of the sheet, and the prism portion has a plurality of prism units, each having a triangular cross-section, formed regularly in a longitudinal and/or width direction of the sheet.

### FIELD OF THE INVENTION

The present invention relates to a novel optical sheet for a plane light source device (or unit) in a liquid crystal display apparatus. More specifically, the present invention relates to an optical sheet which prevents a bright line (or emission line) or a dark line from appearing in a plane light source device (or unit) and has a prism function for enhancing the luminance (or brightness).

### BACKGROUND OF THE INVENTION

A display apparatus using a backlight (e.g., a liquid crystal display apparatus) uses a plane light source unit (or a backlight unit) for illuminating a display panel (e.g., a liquid crystal display module) from a backside thereof. In order to uniformize the illuminating light and enhance the luminance (or brightness) in the front side of the liquid crystal display apparatus, the plane light source unit comprises alight guide plate, a diffusion sheet, a prism sheet, and a brightness (or luminance) enhancement sheet (e.g., a reflective polarizing plate).

The plane light source device comprises, for example, as shown in FIG. 16, a tubular light source 161 such as a fluorescent tube (a cold cathode tube) disposed adjacent to a lateral side of a light guide plate 162, the light guide plate 162 for guiding a light from the tubular light source to a display panel, a diffusing plate 163 disposed on the emitting side (or front side) of the light guide plate 162, and a reflector 164 disposed on the back side of the light guide plate. Incidentally, the thickness of the light guide plate 162 at the side adjacent to the tubular light source 161 is larger than that at the other side, the light from the tubular light source 161 is guided by the light guide plate 162, reflected by the reflector 164, emerged from the emerging surface (front) of the light guide plate 162, diffused by the diffusing plate 163, and then entering the plane display unit (not shown) constructed (laminated) on the diffusing plate. Moreover, on the bottom of the light guide plate 162, white scatterers are regularly arranged as dots in order to scatter a light extensively and radially, or an uneven (or irregular) shape is formed in order to reflect a light to an intended direction.

Further, in order to improve the luminance, the diffusing plate 163 often has a first prism sheet disposed thereon, which has a plurality of prism units formed in parallel with each other so as to form a prism array. In order to further improve the luminance, a second prism sheet is sometimes disposed so that the arrayed direction of the prism array of the second prism sheet is approximately perpendicular to that of the first prism sheet.

For example, Japanese Patent Application Laid-Open No. 162616/1998 (JP-10-162616A, claim 1, paragraph number [0009]) discloses a light guide unit which comprises a flat rectangular light guide plate for guiding an incident light from an incident surface located in an end face thereof to an light-emitting surface, a diffusion sheet disposed in the light-emitting surface side of the light guide plate, a condensing sheet disposed in the light-emitting surface side of the light guide plate, and a frame comprising a shoulder for light-shielding a side-edge part of the back side of the light guide plate in the light-entering surface side of the light guide plate, the side-edge part of the back side of the light guide plate being placing to the shoulder. The diffusion sheet mainly has a function for diffusing a bright line or a dark line generated from the four corners of the light guide plate to make the line invisible and is used in combination with a prism sheet to contribute to the improvement of luminance. However, use of the diffusion sheet and the prism sheet superposed thereon not only requires a plurality of sheets but also produces an interference pattern.

Moreover, Japanese Patent Application Laid-Open No. 109925/1994 (JP-6-109925A, claim 1)) discloses an optical film formed from a transparent material. The optical film has a first surface which has a wave structure having a plurality of isosceles-triangular prisms formed in parallel with each other and a second surface which has an optical uneven structure for diffusing and transmitting light. However, in the film, prevention of the above-mentioned interference pattern is insufficient, and the use of the film alone has insufficient preventive effects on generation of the bright line or the dark line in the plane light source device.

### SUMMARY OF THE INVENTION

It is therefore an object of the present invention to provide an optical film which can prevent generation of a bright line or a dark line in a plane light source device (or unit) for a liquid crystal display apparatus or the like and enhance the luminance (or brightness), and a plane light source device (or unit) comprising the optical film.

Another object of the present invention is to provide an optical film which can prevent generation of an interference pattern and a plane light source device (or unit) comprising the optical film.

The inventors of the present invention made intensive studies to achieve the above objects and finally found that a sheet which comprises a dispersed phase and a transparent continuous phase and has a surface forming a prismatic surface (or a structured surface) of a prism portion can prevent generation of a bright line or a dark line in a plane light source device used in a liquid crystal display apparatus or the like and can enhance the luminance. The present invention has been accomplished based on the above findings.

That is, the optical sheet of the present invention comprises a continuous phase comprising a transparent material and a dispersed phase dispersed in the continuous phase, and having a first surface and a second surface. In the optical sheet, at least one of the first surface and the second surface forms a prismatic surface of a prism portion (or region or zone) constituting portion of the sheet, the prism portion (or prism-containing portion) has a plurality of prism units (or prism elements) formed regularly in a longitudinal and/or width direction of the sheet, and each prism unit (or prism element) has a triangular cross-section. The prism units (e.g., long prism units) may be formed in parallel with each other (or in a row) and form a prism array. Each of the prism units may have an isosceles triangular cross-section with a vertex angle of 60 to 120°. The prism units may have a pitch (or a distance) of about 10 to 1000 μm, and the thickness of the sheet may be about 30 to 3000 μm including a height of the prism unit. The continuous phase may comprise a first transparent thermoplastic resin, and the dispersed phase may comprise a second thermoplastic resin having a different refractive index from that of the first thermoplastic resin.

The dispersed phase may be a modified shape (or deformed shape or non-spherical shape) being a mean aspect ratio of larger than 1. The mean length of the minor axis of the dispersed phase may be about 0.1 to 10 μm, and the mean aspect ratio of the dispersed phase may be about 1.1 to 1000. In such an optical sheet having an elliptical or rectangular dispersed phase, the prism units may be formed in parallel with each other and form a prism array, and the major-axis direction of the dispersed phase may be approximately parallel to the axial (or longitudinal) direction of the prism units. Moreover, such an optical sheet having an elliptical or rectangular dispersed phase may further comprise a flat base portion (or region or zone), and the prism portion may protrude from the base portion, the prism units may be formed in parallel with each other and form a prism array, the major-axis direction of the dispersed phase may be approximately perpendicular to the axial (or longitudinal) direction of the prism units, and in the prism portion the major-axis direction of the dispersed phase may be approximately parallel to the prismatic surface of the prism portion, and in the base portion the major-axis direction of the dispersed phase may be approximately parallel to a planar surface of the base portion.

The absolute difference in refractive index between the continuous phase and the dispersed phase may be not less than 0.001. The proportion (weight ratio) of the continuous phase relative to the dispersed phase may be about 99.9/0.1 to 30/70. In the optical sheet, at least one of the first and second surfaces may have a transparent resin layer formed thereon. The mean thickness ratio of the transparent resin layer may be about 1 to 50% of the whole thickness of the sheet.

The present invention includes a plane light source device (or unit) comprising a light source, a light guide plate, a reflection means, and the above-mentioned optical sheet (first optical sheet), and in the device, the first optical sheet is disposed adjacent to a first surface of the light guide plate, and the reflection means is disposed adjacent to a second surface of the light guide plate. The plane light source device may further comprise a second optical sheet, and in the first optical sheet, the prism unit may be formed in parallel with each other and form a prism array, the second optical sheet may have a prism portion having a plurality of prism units formed in parallel with each other and forming a prism array, the first and second optical sheets may be disposed so that the axial (or longitudinal) directions of the prism units of the first and second optical sheets may be perpendicular to each other, and at least one of the first and second optical sheets may be the sheet of the present invention. The plane light source device may further comprise at least one member selected from the group consisting of a diffusion sheet, a polarization-transforming brightness enhancement sheet, and a view control sheet.

### BRIEF DESCRIPTION OF THE DRAWINGS

FIG. 1 is a schematic sectional view illustrating an example of the optical sheet (the prism sheet) of the present invention using a diffusive semitransparent material.

FIG. 2 is a schematic sectional view illustrating an example of the optical sheet of the present invention having transparent resin layers each formed on both sides of the sheet.

FIG. 3 is a conceptual view for explaining anisotropy (directivity) of light diffusion.

FIG. 4 is a view explaining a light-condensing mechanism of an ordinary transparent prism sheet.

FIG. 5 is a graph illustrating a relationship between an incident angle and an outgoing angle in a transparent prism sheet.

FIG. 6 is a graph for explaining an outgoing light generated in an ordinary transparent prism sheet to a wide angle.

FIG. 7 is a schematic sectional view explaining a light-condensing effect and a light-diffusing effect in an example of the isotropic diffusive optical sheet of the present invention.

FIG. 8 is a schematic perspective view illustrating an example of the anisotropic diffusive optical sheet of the present invention.

FIG. 9 is a schematic perspective view explaining a light-condensing effect and a light-diffusing effect by the optical sheet shown in FIG. 8.

FIG. 10 is a schematic sectional view illustrating another example of the anisotropic diffusive optical sheet of the present invention.

FIG. 11 is a schematic sectional view explaining a light-condensing effect and a light-diffusing effect by the optical sheet shown in FIG. 10.

FIG. 12 is a schematic sectional view illustrating an example of the optical sheet shown in FIG. 10 having transparent resin layers each formed on both sides thereof.

FIG. 13 is a schematic exploded sectional view illustrating an example of a plane light source device using the optical sheet of the present invention.

FIG. 14 is a schematic exploded sectional view illustrating an example of a plane light source device using the optical sheet shown in FIG. 8.

FIG. 15 is a schematic exploded sectional view illustrating an example of a plane light source device using the optical sheet shown in FIG. 12.

FIG. 16 is a schematic sectional view of an example of a plane light source device used in a transmissive liquid crystal display apparatus.

### DETAILED DESCRIPTION OF THE INVENTION

### Optical Sheet

The optical sheet (prism sheet) of the present invention comprises a diffusive semitransparent material and has a first surface and a second surface, and at least one of these surfaces forms prismatic surface of a prism portion constituting portion of the sheet. The prism portion (or prism-containing region) has a plurality of prism units (or prism elements) disposed regularly in a longitudinal and/or width direction of the sheet, and each prism unit has a triangular cross-section.

Each of the prism units (e.g., long prism units) is not particularly limited to a specific one as long as the unit has a triangular cross-section and a prism function, which scatters a light. The prism unit may be in the shape of a quadrangular pyramid. In the present invention, the prism unit is preferably in the shape of a triangular prism (or a triangle pole). Further, among others, it is preferable that the prism unit have a cross-section in the form of an isosceles triangle or a scalene triangle similar to an isosceles triangle (hereinafter, the both are collectively referred to as an “approximately isosceles triangle” or “approximately isosceles triangular”).

In particular, a triangular prism comprising a diffusive semitransparent material and having an approximately isosceles triangular cross-section can decrease a useless wide-angle light leakage, which is generated in a conventional transparent isosceles triangular prism, by suitably selecting the range of the light diffusivity, the thickness of a base portion of the optical sheet, and the vertex angle. In addition, since such a prism diffuses an incident light and leads the light to a front side thereof wherever possible, a novel optical sheet having both a light-diffusing property and a light-condensing effect can be formed. That is, the sheet not only prevents generation of a bright line or a dark line of a plane light source device used in a liquid crystal display apparatus but also carries out a prism function which improves the luminance (or brightness).

The formation (or disposition) of the prism units is not particularly limited to a specific one as long as the units are formed regularly in a longitudinal and/or width direction of the sheet. The prism units are preferably formed in parallel with each other (or formed side by side) so as to form a prism array.

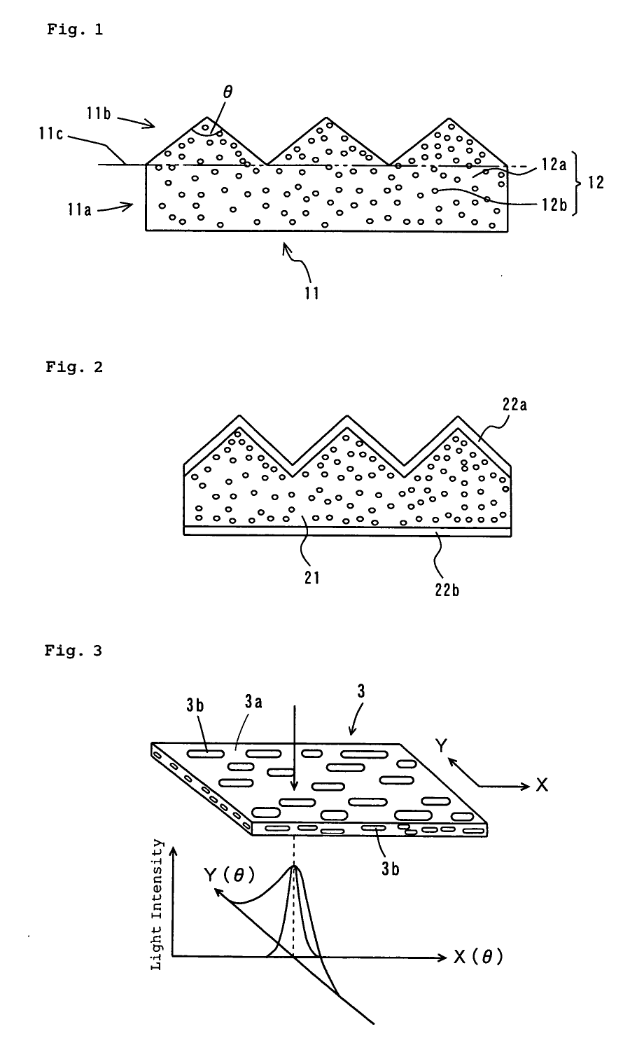

FIG. 1 is a schematic sectional view of a sheet having a prism array by forming a plurality of triangular prism units in parallel with each other (or side by side), each having an isosceles triangular cross-section. In FIG. 1, an optical sheet 11 of the present invention comprises a diffusive semitransparent material 12 having a transparent thermoplastic resin 12a and a fine solid light-scatterer 12b dispersed in the resin 12a. The optical sheet 11 contains a base portion (or a lower generally planar (flat) portion) 11a and a prism portion (or an upper prism-containing portion (or zone)) 11b having a prismatic surface forming a first surface of the sheet. The prism portion 11b contains a plurality of spaced apart prism units (or prism elements). The base portion (or lower portion (or zone)) 11a and the prism portion (or upper portion (or zone)) 11b are separated by imaginary (phantom) line 11c. More specifically, the isosceles triangular cross-section of each prism unit forming the prism portion (or prism-containing zone) 11b has two congruent sides protruded from the base portion (or planar zone) 11a and a virtual third side or base (that is, the prism portion 11b protrudes from the base portion 11a so as to have a plurality of prism units (or prism elements), each having a first prism side and a second prism side adjacent to an angle (a vertex angle)). Incidentally, in order to prevent the base portion 11a from adhering to a contact object, the base portion has a roughened surface as a back side thereof (i.e., a side not having the prism portion) (not shown).

In such an optical sheet, although the triangular cross-sections of respective prism units are equal in FIG. 1, respective prism units may have different cross-sectional sizes from each other. For example, prisms having approximately isosceles triangular cross-sections different in size and/or angle from each other may be used in combination to change the light-condensing property.

In the prism unit having an isosceles triangular cross-section, the vertex angle θ may be, for example, selected from the range of 60 to 120° and preferably 70 to 110° depending on the usage. When the optical sheet of the present invention is used as a diffusion sheet, a vertex angle smaller than 100° (e.g., a vertex angle of 65 to 100°) of the prism unit brings about a light-condensing effect as well as preventing generation of a bright line or a dark line. However, compared with a transparent prism sheet having the same vertex angle, the light-condensing effect is reduced due to the light-diffusing effect. Accordingly, in order to obtain the same level front luminance (or front brightness) that of the transparent prism sheet, a smaller vertex angle (e.g., about 70 to 90°) is preferred. Incidentally, in the case of a smaller vertex angle, the transparent prism sheet has a narrower width of the luminance distribution as a shortcoming. In contrast, the optical sheet of the present invention does not have the above-mentioned shortcoming since the width of the luminance distribution of the optical sheet is broader than that of the transparent prism sheet having the same vertex angle because of the scattering effect. As a result, the optical sheet of the present invention has a light-condensing effect equivalent of that of the transparent prism sheet as well as a function which can prevent generation of a bright line or a dark line.

The pitch of the prism units (particularly, the pitch of the prism lines each having a triangular cross-section) is, for example, about 10 to 1000 μm, preferably about 20 to 500 μm (e.g., about 30 to 300 μm), and more preferably about 40 to 100 μm (particularly, about 50 to 75 μm). When the pitch of the prism units is in this range, the optical sheet can be easily produced. In addition, since it is difficult to recognize the roughness visually, a good plane light source can be formed. Incidentally, the pitch of the prism units means the shortest distance between a vertex of a prism unit and that of the next prism unit.

The thickness of the optical sheet including a height of the prism unit (in the case of a sheet comprising a prism portion and a base portion, the total thickness from the vertex of the prism unit of the prism portion to the bottom surface of the base portion) may be selected from the range of about 30 to 3000 μm. For example, the thickness may be about 35 to 1000 μm, preferably about 40 to 500 μm, more preferably about 50 to 300 μm, and usually about 75 to 250 μm (e.g., about 100 to 125 μm). A sheet having a thickness within this range is easily produced and improves in strength.

The thickness of the base portion of the sheet may be, for example, about 20 to 2000 μm, preferably about 50 to 600 μm, and more preferably about 75 to 150 μm (particularly, about 100 to 125 μm).

In an optical sheet comprising the prism portion and the base portion, the thickness ratio of the prism portion relative to the base portion [the prism portion/the base portion] is, for example, about 10/1 to 1/10, preferably about 4/1 to 1/5, and more preferably about 2/1 to 1/3 (particularly, about 1.5/1 to 1/2).

The optical sheet having such a structure comprises a diffusive semitransparent material. The diffusive semitransparent material usually comprises a continuous phase (a resin (or resinous) continuous phase, a matrix resin) and a dispersed phase (a scattering factor such as a particulate or fibrous dispersed phase) dispersed in the continuous phase.

(Continuous Phase)

The continuous phase comprises a transparent material, usually a transparent resin. The transparent resin may include, for example, a thermoplastic resin [for example, an olefinic resin, a cyclic olefinic resin, a halogen-containing resin (including a fluorine-containing resin), a vinyl alcohol-series resin, a vinyl ester-series resin, a vinyl ether-series resin, a (meth)acrylic resin, a styrenic resin, a polyester-series resin, a polyamide-series resin, a polycarbonate-series resin, a thermoplastic polyurethane resin, a polysulfone-series resin (such as a polyether sulfone or a polysulfone), a polyphenylene ether-series resin (such as a polymer of 2,6-xylenol), a cellulose derivative, a thermoplastic elastomer (such as a polyester-series elastomer, an olefinic elastomer, a polyamide-series elastomer, or a styrenic elastomer), a silicone resin (such as a polydimethylsiloxane or a polymethylphenylsiloxane), and a rubber or elastomer (e.g., a diene-series rubber such as a polybutadiene or a polyisoprene, a styrene-butadiene copolymer, an acrylonitrile-butadiene copolymer, an acrylic rubber, a urethane rubber, and a silicone rubber)], and a thermosetting resin (e.g., an epoxy resin, an unsaturated polyester resin, a diallyl phthalate resin, and a silicone resin). These transparent resins may be used singly or in combination. The preferred resin includes a thermoplastic resin.

The olefinic resin may include, for example, a homo- or copolymer of a C₂₋₆olefin (e.g., an ethylene-series resin such as a polyethylene or an ethylene-propylene copolymer, a polypropylene-series resin such as a polypropylene or a propylene-ethylene copolymer, a poly(methylpentene-1), and a propylene-methylpentene copolymer), a copolymer of a C₂₋₆olefin and a copolymerizable monomer [e.g., a copolymer such as an ethylene-vinyl acetate copolymer, an ethylene-vinyl alcohol copolymer, an ethylene-(meth)acrylic acid copolymer or a salt thereof (e.g., an ionomer resin), or an ethylene-(meth)acrylate copolymer].

The cyclic olefinic (alicyclic olefinic) resin may include, for example, a homo- or copolymer of a cyclic olefin (such as norbornene or dicyclopentadiene) (e.g., a polymer having a sterically inflexible alicyclic hydrocarbon group (such as tricyclodecane)), and a copolymer of the above-mentioned cyclic olefin and a copolymerizable monomer (e.g., an ethylene-norbornene copolymer and a propylene-norbornene copolymer). The alicyclic olefinic resin can be available as, for example, trade name “ARTON”, trade name “ZEONEX”, or others.

The halogen-containing resin may include, for example, a vinyl halide-series resin (e.g., a homopolymer of a halogen-containing monomer such as a polyvinyl chloride, and a copolymer such as a vinyl chloride-vinyl acetate copolymer or a vinyl chloride-(meth)acrylate copolymer) and a vinylidene halide-series resin (e.g., a copolymer such as a polyvinylidene chloride, a polyvinylidenefluoride, or a vinylidene chloride-(meth)acrylate copolymer).

The vinyl alcohol-series resin may include a derivative of a vinyl ester-series resin. The derivative of the vinyl ester-series resin may include, for example, a polyvinyl alcohol, an ethylene-vinyl alcohol copolymer, and a polyvinyl acetal resin.

The vinyl ester-series resin may include, for example, a homo- or copolymer of a vinyl ester-series monomer (e.g., a polyvinyl acetate), a copolymer of a vinyl ester-series monomer and a copolymerizable monomer (e.g., a vinylacetate-ethylene copolymer and a vinylacetate-vinyl chloride copolymer), or a derivative thereof.

The vinyl ether-series resin may include, for example, a homo- or copolymer of a vinyl C₁₋₁₀alkyl ether such as vinyl methyl ether or vinyl t-butyl ether, and a copolymer of a vinyl C₁₋₁₀alkyl ether and a copolymerizable monomer (e.g., a copolymer of a vinyl alkyl ether and maleic anhydride).

The (meth)acrylic resin may include a homo- or copolymer of a (meth)acrylic monomer, and a copolymer of (meth)acrylic monomer and a copolymerizable monomer. The (meth)acrylic monomer may include, for example, (meth)acrylic acid; a C₁₋₁₀alkyl (meth)acrylate such as methyl (meth)acrylate, ethyl (meth)acrylate, butyl (meth)acrylate, t-butyl (meth)acrylate, hexyl (meth)acrylate, or 2-ethylhexyl (meth)acrylate; an aryl (meth)acrylate such as phenyl (meth)acrylate; a hydroxyalkyl (meth)acrylate such as hydroxyethyl (meth)acrylate or hydroxypropyl (meth)acrylate; glycidyl (meth)acrylate; an N,N-dialkylaminoalkyl (meth)acrylate; (meth)acrylonitrile; and a (meth)acrylate having an alicyclic hydrocarbon group such as tricyclodecyl group. The copolymerizable monomer may include a styrenic monomer (e.g., styrene), a vinyl ester-series monomer (e.g., vinyl acetate), an unsaturated carboxylic acid-series monomer (e.g., maleic acid, maleic anhydride, and fumaric acid), and others. These monomers may be used singly or in combination.

More specifically, the (meth)acrylic resin includes, for example, a poly(C₁₋₆alkyl (meth)acrylate) such as a poly(methyl methacrylate) [particularly, a methyl methacrylate-series resin containing methyl methacrylate unit as a main unit (about 50 to 100% by weight and preferably about 70 to 100% by weight)], a methyl methacrylate-(meth)acrylic acid copolymer, a methyl methacrylate-(meth)acrylate copolymer, a methyl methacrylate-acrylate-(meth)acrylic acid copolymer, and a (meth)acrylate-styrene copolymer (e.g., an MS resin).

The styrenic resin may include a homo- or copolymer of a styrenic monomer (e.g., a polystyrene, a styrene-α-methylstyrene copolymer, and a styrene-vinyltoluene copolymer), a copolymer of a styrenic monomer and a copolymerizable monomer (e.g., a (meth)acrylic monomer, maleic anhydride, a maleimide-series monomer, and a diene), and others. The styrenic copolymer may include, for example, a styrene-acrylonitrile copolymer (an AS resin), a copolymer of styrene and a (meth)acrylic monomer [e.g., a styrene-(meth)acrylate copolymer such as a styrene-methyl methacrylate copolymer], and a styrene-maleic anhydride copolymer. The preferred styrenic resin includes a copolymer containing styrene unit and methyl methacrylate unit as main units (such as a polystyrene or a styrene-methyl methacrylate copolymer), an AS resin, a styrene-butadiene copolymer, and others.

The polyester-series resin may include an aromatic polyester containing an aromatic dicarboxylic acid unit [e.g., a homopolyester such as a polyC₂₋₄alkylene terephthalate (such as a polyethylene terephthalate or a polybutylene terephthalate) or a polyC₂₋₄alkylene naphthalate, and a copolyester containing a C₂₋₄alkylene arylate unit (a C₂₋₄alkylene terephthalate and/or a C₂₋₄alkylene naphthalate unit) as a main unit (e.g., not less than 50% by mol, preferably about 75 to 100% by mol, and more preferably about 80 to 100% by mol)], a polyarylate-series resin, an aliphatic polyester containing an aliphatic dicarboxylic acid unit such as adipic acid unit, a homo- or copolymer of a lactone such as ε-caprolactone, a liquid crystalline polyester, and others. Among the aromatic polyesters, the copolyester may include a copolyester in which at least one of C₂₋₄alkylene glycol units in constitutional units of a polyC₂₋₄alkylene arylate is replaced with a polyoxyC₂₋₄alkylene glycol, a C₆₋₁₀alkylene glycol, an alicyclic diol (such as cyclohexanedimethanol or hydrogenated bisphenol A), or a diol having an aromatic ring [e.g., 9,9-bis(4-(2-hydroxyethoxy)phenyl)fluorene having a fluorenone side chain, bisphenol A, and a bisphenol A-alkylene oxide adduct] and a copolyester in which at least one of an aromatic dicarboxylic acid unit is replaced with an asymmetric aromatic dicarboxylic acid (such as phthalic acid or isophthalic acid), an aliphatic C₆₋₁₂dicarboxylic acid (such as adipic acid), or others. The preferred polyester-series resin includes an amorphous polyester such as an amorphous copolyester (e.g., a C₂₋₄alkylene arylate-series copolyester).

The polyamide-series resin may include an aliphatic polyamide (e.g., a polyamide 46, a polyamide 6, a polyamide 66, a polyamide 610, a polyamide 612, a polyamide 11, and a polyamide 12), an aromatic polyamide obtainable from a dicarboxylic acid (such as terephthalic acid, isophthalic acid, or adipic acid) and a diamine (such as hexamethylenediamine or m-xylylenediamine) [e.g., a xylylenediamine adipate (MXD-6)], and others. Moreover, the polyamide-series resin may be a homo- or copolymer of alactam (e.g., ε-caprolactam). The polyamide-series resin may be either a homopolyamide or a copolyamide.

The polycarbonate-series resin may include an aromatic polycarbonate containing a bisphenol unit (e.g., bisphenol A unit) as a base unit, an aliphatic polycarbonate (e.g., diethylene glycol bis(allyl carbonate)), and others.

The cellulose derivative may include a cellulose ester, a cellulose carbamate, and a cellulose ether. The cellulose ester may include, for example, an aliphatic organic acid ester (e.g., a cellulose acetate such as a cellulose diacetate or a cellulose triacetate; an ester of a C₁₋₆organic acid with a cellulose, such as a cellulose propionate, a cellulose butyrate, a cellulose acetate propionate, or a cellulose acetate butyrate), an aromatic organic acid ester (e.g., an ester of a C₇₋₁₂aromatic carboxylic acid with a cellulose, such as a cellulose phthalate or a cellulose benzoate), and an inorganic acid ester (such as a cellulose phosphate or a cellulose sulfate). The cellulose derivative may be an ester of a mixed acid with a cellulose, such as a cellulose acetate nitrate. The cellulose carbamate may include, for example, a cellulose phenylcarbamate. The cellulose ether may include, for example, a cyanoethyl cellulose; a hydroxyC₂₋₄alkyl cellulose such as a hydroxyethyl cellulose or a hydroxypropyl cellulose; a C₁₋₆alkyl cellulose such as a methyl cellulose or an ethyl cellulose; a carboxymethyl cellulose or a salt thereof, a benzyl cellulose, an acetylalkyl cellulose; and others.

In these thermoplastic resins, the resin constituting the continuous phase may be a crystalline resin or an amorphous resin. When one of the continuous phase and the dispersed phase comprises a crystalline resin, the other preferably comprises an amorphous resin.

The crystalline resin may include an olefinic resin [for example, a polypropylene-series resin having a propylene content of not less than 90% by mol (e.g., a polypropylene and a propylene-ethylene copolymer), and a poly(methylpentene-1)], a vinylidene-series resin (e.g., a vinylidene chloride-series resin), an aromatic polyester-series resin (e.g., a polyalkylene arylate homopolyester such as a polyalkylene terephthalate or a polyalkylene naphthalate, a copolyester having an alkylene arylate unit content of not less than 80% by mol, and a liquid crystalline aromatic polyester), a polyamide-series resin (e.g., an aliphatic polyester having a short-chain segment, such as a polyamide 46, a polyamide 6, or a polyamide 66), and others. These crystalline resins may be used singly or in combination. The degree of crystallinity of the crystalline resin (e.g., a crystalline polypropylene-series resin) is, for example, about 10 to 80%, preferably about 20 to 70%, and more preferably about 30 to 60%.

The amorphous resin may include, for example, a vinyl-series polymer [e.g., a homo- or copolymer of a vinyl-series monomer, such as an ionomer, an ethylene-vinyl acetate copolymer, an ethylene-(meth)acrylate copolymer, a polyvinyl chloride, a vinyl chloride-vinyl acetate copolymer, a polyvinyl acetate, or a vinyl alcohol-series resin], a (meth)acrylic resin [e.g., a poly(methyl methacrylate), and a methylmethacrylate-styrene copolymer (an MS resin)], a styrenic resin (e.g., a polystyrene, an AS resin, and a styrene-methyl methacrylate copolymer), a polycarbonate-series polymer, an amorphous polyester-series resin (e.g., an aliphatic polyester, a polyalkylene arylate copolyester in which at least one of diol components and/or aromatic dicarboxylic acid components is replaced, and a poly arylate resin), a polyamide-series resin (an aliphatic polyamide having a long-chain segment, an amorphous aromatic polyamide), and a thermoplastic elastomer (e.g., a polyester-series elastomer, an olefinic elastomer, a polyamide-series elastomer, and a styrenic elastomer). In the amorphous polyester-series resin, the polyalkylene arylate copolyester may include a copolyester in which at least one component selected from the group consisting of a (poly)oxyalkylene glycol (such as diethylene glycol or triethylene glycol), cyclohexanedimethanol, phthalic acid, isophthalic acid, and an aliphatic dicarboxylic acid (e.g., adipic acid) is used as some of diol components (C₂₋₄alkylene glycols) and/or aromatic dicarboxylic acid components (terephthalic acid, naphthalenedicarboxylic acid) (e.g., in a proportion of about 10 to 80% by mol, preferably about 20 to 80% by mol, and more preferably about 30 to 75% by mol). These amorphous resins may be used singly or in combination.

In these transparent thermoplastic resins, usually, a resin having a high transparency and a high heat stability is employed. The preferred transparent thermoplastic resin includes an olefinic resin, a (meth)acrylic resin, a styrenic resin, a polyester-series resin, a polyamide-series resin, a polycarbonate resin, and others. The particularly preferred one includes a crystalline resin having a high flowability as melting property.

(Dispersed Phase)

The shape of the dispersed phase is not particularly limited to a specific one as long as the dispersed phase is dispersed in the continuous phase. For example, the shape of the dispersed phase may include a spherical shape, an ellipsoidal shape, a polyhedral shape (e.g., a pyramid shape, a cubic shape, and a rectangular solid shape), an amorphous (or an odd shape), and the like. In view of the scattering property, a modified (or deformed or non-spherical) shape such as an ellipsoidal shape or a rectangular solid shape is preferred. More specifically, the dispersed phase may be, for example, a spherical-shaped particle having a mean aspect ratio (L/W) of 1 (where the mean aspect ratio (L/W) means a ratio of a mean diameter L of a major axis relative to a mean diameter W of a minor axis). The shape of the dispersed phase is preferably a modified shape having an aspect ratio of larger than 1 (such as an ellipsoidal shape or a rectangular solid shape). The aspect ratio of the dispersed phase having a modified shape is about 1.1 to 1000 (e.g., about 1.5 to 900), preferably about 2 to 800 (e.g., about 3 to 700), more preferably about 5 to 500 (particularly about 20 to 500), and usually about 5 to 300 (particularly about 10 to 100). Such a dispersed phase may be in the shape of a rugby ball (an ellipsoid of gyration), a fiber, a rectangular solid, or the like. The larger the aspect ratio of the dispersed phase is, the higher the anisotropic light-scattering properties the sheet has.

In the dispersed phase having a modified shape, the mean diameter L of the major axis is, for example, about 0.1 to 200 μm, preferably about 1 to 150 μm, more preferably about 2 to 100 μm (particularly about 3 to 50 m), and usually about 10 to 100 μm (e.g., about 10 to 50 μm). Moreover, the mean diameter W of the minor axis in the light-scattering phase is, for example, about 0.01 to 10 μm (e.g., about 0.1 to 10 μm), preferably about 0.15 to 5 μm (e.g., about 0.3 to 4 μm), and more preferably about 0.2 to 3 μm (particularly about 0.5 to 2 μm).

Further, the dispersed phase is different in refractive index from the continuous phase, and usually, the dispersed phase is non-miscible or hardly miscible with the continuous phase.

Such a dispersed phase can be formed by adding an inorganic or organic particle or fiber to a matrix resin constituting the continuous phase or by adding and kneading a resin different in refractive index from the matrix resin to the matrix resin.

The inorganic particle may include, for example, an inorganic oxide (e.g., a silica, an alumina, and titanium oxide), a salt of carbonic acid (e.g., calcium carbonate), a salt of sulfuric acid (e.g., barium sulfate), and a natural mineral or a salt of silic acid (e.g., a talc). The organic particle may include, for example, a cross-linked resin particle such as a cross-linked styrenic resin (e.g., a cross-linked polystyrene), a cross-linked acrylic resin (e.g., a cross-linked poly(methyl methacrylate)), or a cross-linked guanamine-series resin. The inorganic fiber may include, for example, a fibrous filler (an inorganic fiber such as a glass fiber, a silica fiber, an alumina fiber, or a zirconia fiber) and a flaky filler (e.g., a mica). The organic fiber may include, for example, a heat-resistant organic fiber such as an aramid fiber, a fully aromatic polyester fiber, or a polyamide fiber.

The resin different in refractive index from the matrix resin may include the above-mentioned transparent resin. These transparent resins may be used singly or in combination.

If necessary, the above-mentioned transparent resin may be a modified one (for example, a rubber-modified resin). Moreover, the resin component constituting the dispersed phase may be graft- or block-copolymerized to the matrix resin constituting the continuous phase. Such a polymer may include, for example, a copolymer having a rubber block (e.g., a styrene-butadiene copolymer (an SB resin)) and a rubber-grafted styrenic resin (e.g., an acrylonitrile-butadiene-styrene copolymer (an ABS resin)).

A resin which has a high transparency, is easily formed at an orientation treatment temperature in a step of drawing or uniaxial-stretching in a molten state for forming a film by extrusion, and has a suitable heat stability for practical use is employed as the resin constituting the dispersed phase. Such a resin may include, for example, an olefinic resin, a (meth)acrylic resin, a styrenic resin, a polyester-series resin, a polyamide-series resin, and a polycarbonate resin. In particular, the amorphous resin exemplified in the paragraph of the above-mentioned continuous phase, particularly, an amorphous copolyester-series resin and a styrenic resin are preferred. The amorphous copolyester includes, for example, a polyethylene terephthalate copolyester obtainable by using a diol component containing ethylene glycol and cyclohexanedimethanol in a molar ratio [ethylene glycol/cyclohexanedimethanol] of about 10/90 to 60/40 and particularly about 25/75 to 50/50, a copolyester obtainable by using 9,9-bis(4-(2-hydroxyethoxy)phenyl)fluorene having a fluorenone side chain as a diol component. The styrenic resin includes, for example, a polystyrene (GPPS). Each of the amorphous copolyester and the styrenic resin has a high refractive index (e.g., a refractive index of about 1.57 to 1.59) and is relatively easily compounded with the crystalline resin (e.g., a polypropylene-series resin) which constitutes the continuous phase.

The difference (absolute value) in refractive index between the continuous phase and the dispersed phase is, for example, not less than 0.001 (e.g., about 0.001 to 0.3), preferably about 0.005 to 0.2, and more preferably about 0.01 to 0.15 (particularly about 0.02 to 0.1).

The proportion (weight ratio) of the continuous phase relative to the dispersed phase [the former/the latter] may be, for example, about 99.9/0.1 to 30/70 (e.g., about 99.7/0.3 to 40/60), preferably about 99.5/0.5 to 50/50, and more preferably about 99/1 to 60/40 (particularly about 98/2 to 75/25). For example, the proportion may be about 90/10 to 60/40 (particularly about 80/20 to 60/40).

(Compatibilizer)

The optical sheet (diffusive semitransparent material) may contain a compatibilizer, if necessary. The use of the compatibilizer can improve the miscibility and compatibility between the continuous phase and the dispersed phase, and can inhibit generation of defects (defects such as a void) in an orientation treatment of the film and prevent deterioration of transparency of the film. Further, the compatibilizer can enhance the adhesiveness of the dispersed phase to the continuous phase, and can reduce the adhesion of the dispersed phase to a stretching apparatus in a uniaxial stretching of the film.

The compatibilizer may include, for example, an oxazoline compound, a modified resin having a modifying group (e.g., a carboxyl group, an acid anhydride group, an epoxy group, and an oxazolinyl group) introduced thereto, a diene- or rubber-containing polymer [for example, a homopolymer of a diene-series monomer, or a diene-series copolymer obtainable by copolymerization of a diene-series monomer and a copolymerizable monomer (such as an aromatic vinyl monomer) (e.g., a random copolymer); a diene-series graft copolymer such as an acrylonitrile-butadiene-styrene copolymer (an ABS resin); and a diene-series block copolymer such as a styrene-butadiene (SB) block copolymer, a styrene-isoprene (SI) block copolymer, a hydrogenated styrene-butadiene (SEB) block copolymer, a hydrogenated styrene-butadiene-styrene block copolymer (SEBS), or a hydrogenated styrene-isoprene block copolymer], and a diene- or rubber-containing polymer modified with the above-mentioned modifying group (e.g., an epoxy group). These compatibilizers may be used singly or in combination.

A polymer (a random, block, or graft copolymer) having the same type of components as (or common components with) the resin constituting the continuous phase and/or the dispersed phase, a polymer (a random, block, or graft copolymer) compatible with the resin constituting the continuous phase and/or the dispersed phase, and others are usually employed as the compatibilizer.

In the modified resin, in order to introduce a modifying group to a resin, a monomer corresponding to a modifying group [for example, a carboxyl group-containing monomer (e.g., (meth)acrylic acid) in a resin modified with a carboxyl group, maleic anhydride in a resin modified with an acid anhydride group, a (meth)acrylic monomer in a resin modified with an ester group, a maleimide-series monomer in a resin modified with a maleimide group, and an epoxy group-containing monomer (e.g., glycidyl (meth)acrylate) in an epoxy-modified resin] may be copolymerized. In order to obtain the epoxy-modified resin, a resin may be modified by epoxidation of an unsaturated double bond.

The preferred compatibilizer includes an unmodified or modified diene-series copolymer, particularly, a modified block copolymer (for example, an epoxidized diene-series block copolymer or epoxy-modified diene-series block copolymer such as a styrene-butadiene-styrene (SBS) block copolymer which comprises a conjugated diene block or a partly hydrogenated block thereof and an aromatic vinyl block and in which part or all of double bonds of the conjugated diene block are epoxidized).

The refractive index of the compatibilizer (e.g., the epoxidized block copolymer) may be approximately the same as that of the dispersed phase. The difference (absolute value) in refractive index between the compatibilizer and the dispersed phase may be, for example, about 0 to 0.03, preferably about 0.0001 to 0.02, and more preferably about 0.0005 to 0.01 (particularly about 0.001 to 0.005).

The proportion of the compatibilizer relative to the whole resin composition comprising the continuous phase and the dispersed phase is, for example, about 0.01 to 20% by weight, preferably about 0.03 to 15% by weight, and more preferably about 0.1 to 10% by weight (particularly about 0.2 to 5% by weight). The proportion may be about 0.5 to 15% by weight (e.g., about 1 to 10% by weight).

The proportion (weight ratio) of the dispersed phase relative to the compatibilizer [the dispersed phase/the compatibilizer] is about 99/1 to 50/50, preferably about 99/1 to 70/30, and more preferably about 98/2 to 80/20.

(Ultraviolet Ray Absorbing Agent)

The optical sheet may contain an ultraviolet ray absorbing agent. In particular, in the use of the optical sheet of the present invention for a plane light source device, only the sheet is often placed on the light guide plate. Accordingly, the optical sheet preferably blocks ultraviolet rays outgoing from the light guide plate as much as possible to reduce adverse effects to a crystal cell of the apparatus.

The ultraviolet ray absorbing agent may include, for example, a benzotriazole-series ultraviolet ray absorbing agent [for example, N-hydroxyphenylbenzotriazole, 2-(2′-hydroxy-5′-methylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′,5′-di-t-amylphenyl)benzotriazole, 2,2-methylenebis[4-(1,1,3,3-tetramethylbutyl)-6-(2H-benzotriazole-2-yl)phenol], and [2-(2′-hydroxy-5′-(meth)acryloxyphenyl)-2H-benzotriazole]], a benzophenone-series ultraviolet ray absorbing agent [for example, 2-hydroxybenzophenone, 2,4-dihydroxybenzophenone, 2-hydroxy-4-alkoxybenzophenone (e.g., 2-hydroxy-4-methoxybenzophenone, 2-hydroxy-4-octyloxybenzophenone, 2-hydroxy-4-dodecyloxybenzophenone, bis(2-methoxy-4-hydroxy-5-sulfobenzophenone), and 2-hydroxy-4-methoxy-5-sulfobenzophenone), 2,2′-dihydroxy-4,4′-dimethoxybenzophenone, and bis(2-methoxy-4-hydroxy-5-benzoylphenylmethane)], a benzoate-series ultraviolet ray absorbing agent [e.g., 2,4-di-t-butylphenyl-3,5-di-t-butyl-4-hydroxybenzoate], a salicylic acid-series ultraviolet ray absorbing agent [for example, phenyl salicylate, p-t-butylphenyl salicylate, and p-octylphenyl salicylate], and a triazine-series ultraviolet ray absorbing agent [for example, 2-(4,6-diphenyl-1,3,5-triazin-2-yl)-5-hexyloxy-phenol]. These ultraviolet ray absorbing agents may be used singly or in combination.

A compound having compatibility with or solubility in the resin is usually employed as the ultraviolet ray absorbing agent. The ultraviolet ray absorbing agent is usually dissolved or finely dispersed mainly in the continuous phase. The preferred ultraviolet ray absorbing agent includes a benzotriazole-series ultraviolet ray absorbing agent and a benzophenone-series ultraviolet ray absorbing agent.

The proportion of the ultraviolet ray absorbing agent may be, for example, selected from the range of about 0.1 to 10 parts by weight relative to 100 parts by weight of the total resin component comprising the continuous phase and the dispersed phase. The proportion is usually about 0.1 to 5 parts by weight, preferably about 0.2 to 2.5 parts by weight, and more preferably about 0.5 to 2 parts by weight.

Incidentally, the ultraviolet ray absorbing agent may be used in combination with various stabilizers (such as an antioxidant or a heat stabilizer), particularly, a light stabilizer for inhibiting deterioration of the resin. The stabilizer may include an ultraviolet ray stabilizer (e.g., nickelbis(octylphenyl) sulfide, [2,2-thiobis(4-t-octylphenolate)]-n-butylamine nickel, and nickle-dibutyldithiocarbamate), and a hindered amine-series light stabilizer (e.g., [bis(2,2,6,6-tetramethyl-4-piperidyl) sebacate]).

Further, an ultraviolet ray absorbable fine particle (for example, an inorganic fine particle such as zinc oxide or titanium oxide) may be used in combination as long as the light-scattering properties or the light-transmittance properties are not deteriorated. The proportion of the ultraviolet ray absorbable fine particle is, for example, about 0.01 to 1% by weight and preferably about 0.05 to 0.5% by weight in the resin composition constituting the continuous phase and the dispersed phase.

The optical sheet of the present invention may further contain a conventional additive, for example, a plasticizer, an antistatic agent, a flame retardant, and a filler.

(Transparent Resin Layer)

The optical sheet of the present invention may further have a transparent resin layer formed on at least one surface thereof. The transparent resin layer protects a diffusive transparent material comprising the continuous phase and the dispersed phase. In particular, the transparent resin layer inhibits falling off of the dispersed phase when the dispersed phase comprises a fine light-scatterer. The transparent resin layer may be formed on one surface of the optical sheet, preferably both surfaces thereof.

FIG. 2 is a schematic sectional view illustrating one embodiment of the optical sheet of the present invention having a transparent resin layer on each of surfaces thereof. In FIG. 2, an optical sheet 21 has a transparent resin layer 22a formed on a surface of a prism portion and a transparent resin layer 22b formed on a back side of a base portion (a bottom surface of the optical sheet). Since the optical sheet is protected by these transparent resin layers, the optical sheet is stable over a long period of time and improves in chemical stability. In view of the protective action of the transparent resin layer, it is preferable that each of the prism portion and the base portion have the transparent resin layers formed on the surface thereof. Further, the transparent resin layer formed on the back side of the base portion is preferably roughened for preventing the optical sheet from adhering to an object in contact with the optical sheet.

Transparent resins exemplified in the paragraph of the continuous phase may be used as a transparent resin constituting the transparent resin layer. These transparent resins may be used singly or in combination. In these transparent resins, in order to improve the heat resistance or blocking resistance, a heat-resisting resin (e.g., a resin having a high glass transition temperature or a high melting point), a crystalline resin, and others are preferably used. The glass transition temperature or melting point of the resin constituting the transparent resin layer may be almost the same as that of the resin constituting the continuous phase, for example, may be about 130 to 280° C., preferably about 140 to 270° C., and more preferably about 150 to 260° C. In addition, the transparent resin constituting the transparent resin layer is preferably the same or same series resin as the transparent resin constituting the continuous phase since unwanted reflection hardly occurs between the transparent resin layer as the surface layer and the inner layer comprising the diffusive semitransparent material. The same series resin may be slightly different in structure by copolymerization or the others.

Regarding the thickness of the transparent resin layer, the mean thickness ratio of the transparent resin layer (in the optical sheet having transparent resin layers formed on the both surfaces thereof, the total thickness of the both transparent resin layers) may be selected from the range of about 0.5 to 95% of the whole sheet and is usually about 1 to 50%, preferably about 3 to 40%, and more preferably about 5 to 30%. Incidentally, regarding the thickness ratio of the transparent resin layer, the thickness of the whole sheet was based on the middle point between the vertex and the base of the prism portion. Concretely, when the thickness of the whole sheet is about 50 to 200 μm, the thickness of the transparent resin layer may be about 3 to 150 μm.

(Properties and Structure of Optical Sheet)

In the optical sheet of the present invention, the orientation coefficient of the dispersed phase may be, for example, not less than 0.7 (about 0.7 to 1), preferably about 0.8 to 1, and more preferably about 0.9 to 1. The higher the orientation coefficient of the dispersed phase is, the higher the anisotropy of the scattered light is. Incidentally, the orientation coefficient can be calculated based on the following formula:

Orientation coefficient=(3<cos²θ>−1)/2

wherein, θ represents an angle between the major axis of the particulate light-scattering phase and the X-axis of the film (when the major axis and the X-axis is parallel to each other, θ=0°), <cos²θ> indicates the average of cos²θ calculated from each dispersed phase particle and is represented by the following formula:

<cos²θ>=∫n(θ)·cos²θ·dθ

wherein n(θ) represents a weight ratio of a light-scattering phase having an angle θ in the whole light-scattering phase particle.

The optical sheet (prism sheet) of the present invention may produce a directive diffused light. FIG. 3 is a conceptual view for explaining directivity of light diffusion. This figure illustrates directivity of a light diffused by an optical sheet when omitted the prism portion (an anisotropic light-diffusing film).

In FIG. 3, an anisotropic light-diffusing film 3 comprises a continuous phase 3a and a dispersed phase 3b which are different in refractive index from each other. The continuous phase 3a and the dispersed phase 3b independently comprise a resin having a high transparency. Moreover, the dispersed phase 3b dispersed in the continuous phase 3a has a mean aspect ratio of larger than 1 and can scatter an incident light anisotropically to the traveling direction of the light. More specifically, the dispersed phase 3b can scatter a light entered in the film preferentially to a direction (Y-axis direction) perpendicular to the major-axis direction (X-axis direction) of the dispersed phase particle. Therefore, when the anisotropic scattering sheet 3 is disposed so that the major-axis direction (X-axis direction) of the dispersed phase 3b may be aligned with the longitudinal direction (X-axis direction) of the display surface, the film can scatter a light preferentially to the lateral direction (Y-axis direction).

In the case of the optical sheet (prism sheet) of the present invention, particularly, in the case of the optical film having a plurality of prism units, each having an isosceles triangular cross-section, formed in parallel with each other so as to form a prism array, the above-mentioned X-axis direction or Y-axis direction may be at any angle with the prism lines. In particular, when the longitudinal (or axial) direction of the prism units and the X-axis direction are the same or perpendicular to each other, the optical film exerts excellent properties.

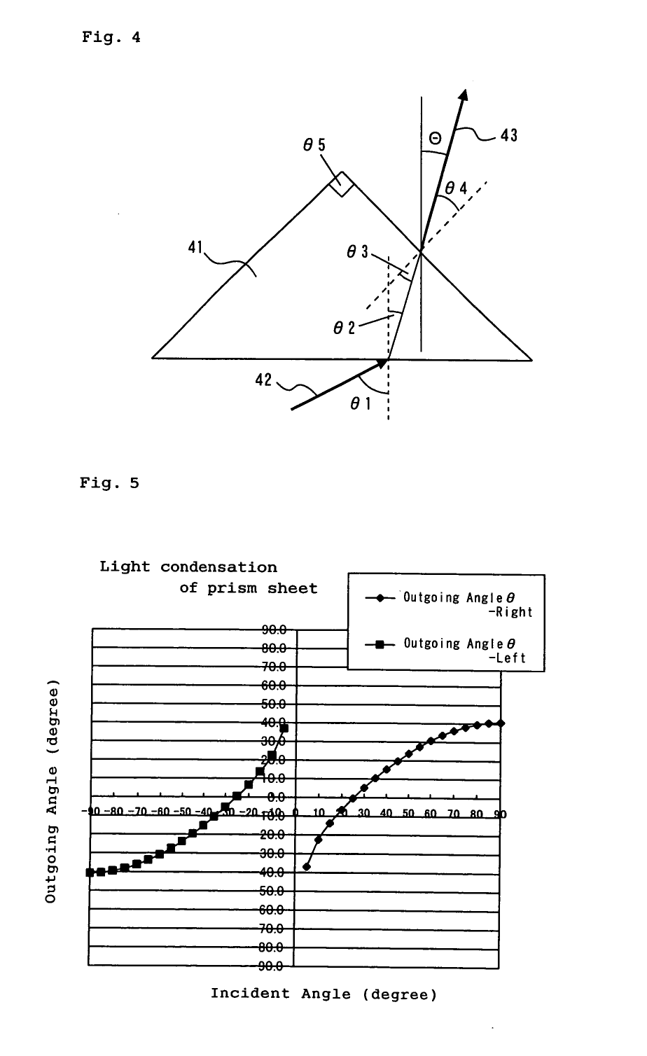

The optical sheet of the present invention has a light-condensing effect due to the prism portion. Firstly, functions of a common prism will be explained. FIG. 4 is a view explaining a light-condensing mechanism of a transparent prism sheet. In a prism unit 41 having an isosceles triangular cross-section, an incident light 42 entered at an incident angle θ1 is refracted on the base of the prism unit and entered into the prism unit at a refraction angle θ2. The entered light reaches a side of the prism unit at an incident angle θ3 and emitted to the outside of the prism at an outgoing angle θ4 as an outgoing light 43.

If the vertex angle θ5 of the cross section of the prism unit is close to 90°, an angle Θ of the outgoing light 43 to the axis perpendicular to the base of the prism unit having an isosceles triangular cross-section satisfies the inequality: Θ<θ1, and the sheet having the prism exerts a light-condensing effect.

Regarding the above-mentioned quantitative relationship, if n=1.49 (acrylic resin) and the vertex angle 59 is 90°, the following expressions hold:

sin θ1/sin θ2=n=1.49 (acrylic resin) (1)

sin θ4/sin θ3=1.49θ3+θ2=45° (2)

Θ=θ4−45° (3)

FIG. 5 is a graph showing the results obtained from calculation from these expressions.

The graph shows that the entered light which has an incident angle of 90° to −90° is emitted at an outgoing angle of 40° to −40° (the entered light which has an incident light of around 0° is completely reflected and is not directly emitted).

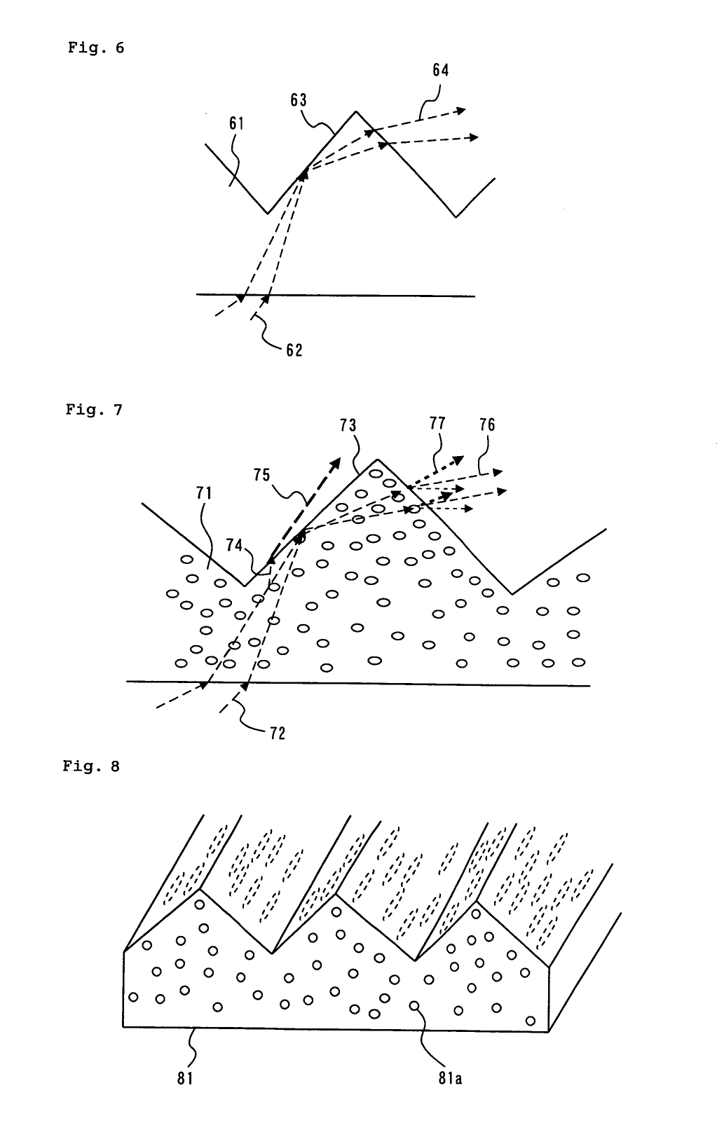

FIG. 6 is a graph for an outgoing light to a wide angle, which is a defect of a conventional prism sheet, compared with the light-condensing effect of the above-mentioned prism. An incident light 62 which enters a specific position of the bottom surface of a prism portion 61 is completely reflected at a first prism side 63 adjacent to a vertex of a prism unit and emitted as a useless outgoing light 64 from a second prism side adjacent to the vertex of the prism unit. In the use of the prism sheet, a light is effectively condensed to the front face (the direction perpendicular to the surface of the sheet). However, the use has a defect that the light is uselessly emitted over a wide angle such as around 80°.

The light emitted at such a wide angle is quite useless for a liquid crystal display apparatus. In addition, such a prism sheet also has a defect that the luminance is drastically reduced at an angle of around 45° due to deterioration of the light-condensing effect.

FIG. 7 is a schematic sectional view for explaining a light-condensing effect and a light-diffusing effect in an example of the optical sheet (prism sheet) of the present invention comprising a diffusive semitransparent material.

An incident light 72 which enters a specific position of the bottom surface of the optical sheet (prism portion) 71 of the present invention is completely reflected at a first prism side 73 adjacent to a vertex of a prism unit. However, part of the light passing through the inside of the sheet is diffused by the diffusive material to give a diffused light 74. The diffused light 74 is emitted as an outgoing light 75 because the incident angle of the diffused light 74 to the first prism side 73 is smaller than the total reflection angle. The light 75 contributes as an outgoing light to improvement of the luminance of a backlight at an outgoing angle of around 45°. Further, a light completely reflected at the first prism side 73 enters a second prism side adjacent to the vertex of the prism unit and emitted as a useless outgoing light 76 to a wide angle. However, due to diffusion, the reflected light gives an outgoing light 77 having a lower outgoing angle than the light 76.

Thus the optical sheet (prism portion) of the present invention basically induces diffusion of a light entered the sheet, and the sheet has a lower light-condensing effect compared with a transparent prism sheet. However, the optical sheet has preventive effects on generation of a bright line or a dark line. Incidentally, in order to provide the front luminance of the optical sheet of the present invention as high as that of the transparent prism sheet, it is preferable that the vertex angle is smaller. For example, the vertex angle is preferably about 70 to 90°. In the transparent prism sheet, the smaller vertex angle causes a narrower distribution of the luminance. On the other hand, in the optical sheet of the present invention, due to the scattering effect, the distribution of the luminance is wider compared with a transparent prism sheet having the same vertex angle.

Accordingly, suitable selections of the concentration of the dispersed phase in the diffusive semitransparent material, the vertex angle of the prism portion, and the thickness of the base portion realizes the optical sheet of the present invention having the same level of light-condensing effects as that of a transparent prism sheet and the preventive effects on generation of the bright line or the dark line.

In the optical sheet of the present invention, the hypothetical total light transmittance under the assumption of a virtual optical sheet having a uniform thickness obtained by leveling the prism portion thereof is, for example, not less than 85% (about 85 to 100%), preferably about 90 to 100%, and more preferably about 90 to 95%. Further, the hypothetical haze under the assumption that the prism portion is leveled is, for example, about 20 to 90%, preferably about 40 to 70%, and more preferably about 50 to 60%.

When the optical sheet of the present invention has the dispersed phase having a modified shape, it is preferable that the dispersion mode have a regularity, in order to improve the anisotropy in the light diffusion of the sheet. In particular, when the prism portion of the optical sheet forms a prism array, it is preferable that the major-axis direction of the dispersed phase has regularity and is approximately parallel or approximately perpendicular to the axial (or longitudinal) direction of the prism units. Furthermore, it is preferable that the major axis direction of the dispersed phase has regularity and is approximately parallel to a prismatic surface of the prism portion and/or a planar surface of the base portion. Such regularity may be selected depending on application. For example, an optical sheet having the following regularity may be explained.

FIG. 8 is a schematic perspective view illustrating an example of the optical sheet of the present invention. An optical sheet 81 shown in FIG. 8 comprises an isosceles triangular prism portion having a plurality of prism units formed in parallel with each other to form a prism array, and a flat base portion. Further, in this sheet, a major-axis direction of a dispersed phase 81a having a modified shape is approximately parallel with (approximately corresponds to) the axial (or longitudinal) direction of the prism array.

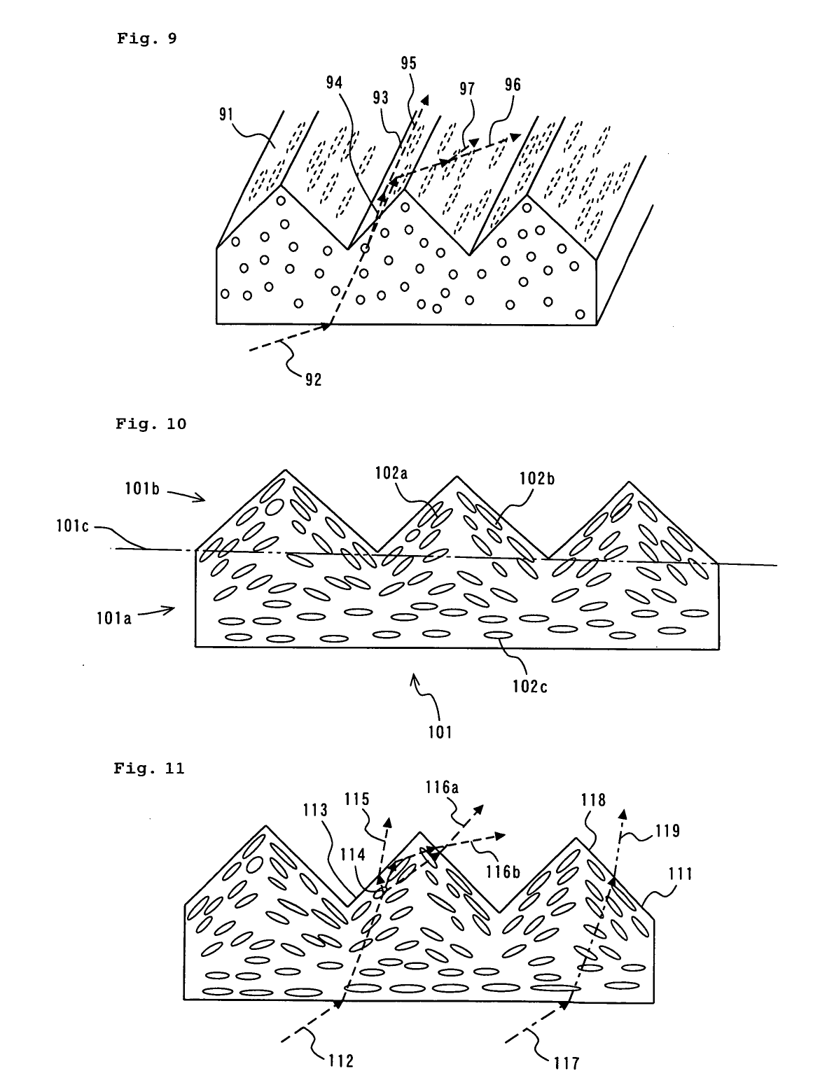

FIG. 9 is a view for explaining a light-condensing effect and a light-diffusing effect in this optical sheet. In this figure, an incident light 92 which enters a specific position of the bottom surface of an optical sheet 91 is completely reflected at a first prism side 93 adjacent to a vertex of a prism unit. However, part of the light passing through the inside of the sheet is diffused by the diffusive material to give a diffused light 94. The diffused light 94 is emitted as an outgoing light 95 because the incident angle of the diffused light to the first prism side 93 is smaller than the total reflection angle. The outgoing light 95 contributes as an outgoing light to improvement of the luminance at an outgoing angle of around 45°. A light completely reflected from the surface 93 enters a second prism side adjacent to the vertex of the prism unit and emitted as a useless outgoing light 96 to a wide angle. However, due to diffusion, the reflected light gives an effective outgoing light 97 having a lower outgoing angle than the light 96.

However, in the sheet shown in FIG. 9, the dispersed phase having a rugby ball shape induces anisotropy of diffusion, and there is little light diffusion to the axial (or longitudinal) direction of the isosceles triangular prism units. Further, since the light is scattered only to the side direction of the prism (the direction perpendicular to the axial (or longitudinal) direction of the prism units), the dispersed phase shown in FIG. 7 (having an approximately spherical shape and inducing isotropic scattering) also induces scattering to a direction perpendicular to the side direction (isotropic scattering). Therefore, the sheet has no defect that an angle between the outgoing light and the front surface increases and has an improved light-condensing effect.

FIG. 10 is a schematic sectional view illustrating another example of the optical sheet of the present invention. The sheet shown in FIG. 10 contains a lower generally planar portion (or base portion) 101a and an upper prism-containing portion (or zone) 101b containing a plurality of spaced apart prism units (or prism elements). The lower portion (or zone) 110a and the upper portion (or zone) 101b are separated by imaginary (phantom) line 101c.

In this sheet, the major-axis direction of the dispersed phase having an approximately spheroid shape (a rugby ball-shaped and light-scattering phase) is approximately perpendicular to the axial (or longitudinal) direction of the prism units.

In this sheet, the dispersed phase (in particular, around the front surface) in the prism portion is approximately parallel to a prismatic surface of the prism portion. More specifically, a dispersed phase 102a is approximately parallel to a first prism side adjacent to a vertex of a prism unit, and a dispersed phase 102b is approximately parallel to a second prism side adjacent to the vertex of the prism unit. Moreover, a dispersed phase 102c (in particular, around the back surface) in the base portion is approximately parallel to the planar surface of the base portion (back surface). Further, most of dispersed phases existing between the dispersed phases 102a, 102b, and the dispersed phase 102c have inclination angles depending on the position thereof, and those angles gradually changes from that of the dispersed phases 102a or 102b to that of the dispersed phase 102c.

FIG. 11 is a view for explaining a light-condensing effect and a light-diffusing effect by such an optical sheet. In this figure, an incident light 112 which enters a specific position in the bottom surface of an optical sheet 111 is completely reflected at a first prism side 113 adjacent to a vertex of a prism unit. However, part of the light passing through the inside of the sheet is diffused by a dispersed phase whose major axis is approximately parallel to a prismatic surface of the prism portion to give a diffused light 114. Regarding this light-diffusing effect, a stronger scattering is provided because any cross-sections of the dispersed phase have almost a circular shape in the direction approximately perpendicular to the prism array due to the major axis direction of the dispersed phase approximately perpendicular to the axial (or longitudinal) direction of the isosceles triangular prism units. Thus part of the light inside of the prism is diffused to give the diffused light 114, and the diffused light 114 is emitted because the incident angle of the diffused light 114 to the first prism side 113 is extremely smaller than the total reflection angle. A light emitted from the surface 113 (an outgoing light 115) contributes to improvement of the luminance at an outgoing angle of around 45°, and in addition, improvement of the luminance in the direction close to the front surface. Moreover, since the diffused light 114 is strong, a light which enters a second prism side adjacent to the vertex of the prism unit is also emitted toward the front surface direction to give a light 116a. Further, a light completely reflected from the surface 113 is extremely reduced, and a useless outgoing light 116b which is emitted from the second prism side to a wide angle is extremely decreased.

Moreover, the optical sheet shown in FIG. 11 provides a weak scattering to the planar surface of the base portion since the major axis direction of the dispersed phase in the base portion is approximately parallel to the planar surface. Accordingly, a light 117 which is entered by a common light-condensing effect reaches the surface 118 of the prism portion without undergoing strong scattering. Further, the incident light 117, unlike the above-mentioned incident light 112, is hardly scattered to the prismatic surface of the prism portion since the major-axis direction of the dispersed phase is approximately parallel to the prismatic surface around the prism side 118, and an outgoing light 119 is emitted in the same manner as in the case of the transparent prism sheet, unlike the surface 113. Therefore, the sheet does not have a significant effect on the light-condensing effect. However, in a plane light source device, the optical sheet inhibits a bright line or a dark line due to some scattering effects.

Thus the optical sheet shown in FIG. 10, particularly in a plane light source device, not only inhibits a bright line or a dark line but also has a prism function improving the luminance.

FIG. 12 is a schematic sectional view illustrating an example of the optical sheet shown in FIG. 10 having transparent resin layers each formed on both sides thereof. In this figure, an optical sheet 121 has a transparent resin layer 122a for protecting a prismatic surface of a prism portion and a transparent resin layer 122b for protecting a bottom surface of a base portion. As a result, the optical sheet is stable to a change with passage of time and has an excellent chemical stability.

[Production Process of Optical Sheet]

The optical sheet (a sheet comprising a diffusive semitransparent material) of the present invention may be, for example, made from a pellet having a continuous phase and a dispersed phase dispersed therein. The pellet may be produced, for example, by blending and melt-mixing a resin component constituting the continuous phase, a component (such as a resin component or a fibrous component) constituting the dispersed phase, and optionally an additive (e.g., an ultraviolet ray absorbing agent) through a conventional manner (for example, a melt-blending method, a tumbler method), subjecting the mixture to an extrusion molding, and cooling the resulting matter.

The optical sheet having a transparent resin layer may be produced by a co-extrusion molding process which comprises forming a film from a diffusive semitransparent material (continuous phase and dispersed phase) and a resin composition comprising a resin component corresponding to a transparent resin layer by a co-extrusion molding, by a process which comprises laminating a first layer which has been formed and a second layer by an extrusion laminating, by a dry-laminating a diffusive semitransparent material and a transparent resin layer which are separately produced, or by other processes.

In the case of the dispersed phase comprising a resin component such as a transparent resin, in order to impart anisotropic light diffusion to the diffusive semitransparent material, a film may be produced by, for example, (1) forming a film by drawing an extrusion-molded sheet, (2) forming a film by uniaxial stretching an extrusion-molded sheet, (3) combination of the above-mentioned (1) and (2), and others. Incidentally, an anisotropic light-diffusing film may be formed by (4) solution-blending each component mentioned above and forming a film the mixture by casting.

The melting temperature is not particularly limited to a specific one as long as the temperature is not lower than the melting point of the resin component (the resin constituting the continuous phase and/or the dispersed phase). The melting temperature is, for example, about 150 to 290° C., preferably about 180 to 280° C., and more preferably about 200 to 260° C. The cooling temperature is not particularly limited to a specific one and may be not higher than 100° C., for example, about 20 to 80° C.

The draw ratio (draft) is, for example, about 2 to 40, preferably about 5 to 30, and more preferably about 7 to 20. The stretching factor is, for example, about 1.1 to 50 (e.g., about 3 to 50) and preferably about 1.5 to 30 (e.g., about 5 to 30). Incidentally, in a combination of drawing and stretching, the draw ratio may be, for example, about 2 to 10, preferably about 2 to 5, and the stretching factor may be about 1.1 to 20 (e.g., about 2 to 20) and preferably about 1.5 to 10 (e.g., about 3 to 10).

In the dispersed phase comprising the resin component, a process for increasing the aspect ratio of the dispersed phase easily may include a stretching of a sheet (for example, a sheet obtained by cooling after film-forming), for example, a tensile drawing, which comprises drawing both ends of a solidified sheet; a roller drawing, which comprises arranging plural pairs (e.g., two pairs) of rollers (two rollers) facing each other in parallel, interposing a sheet between the rollers facing each other, laying the sheet between a first pair of rollers (feed rollers) and a second pair of rollers (withdrawal rollers), and stretching the sheet by making the withdrawal rate of the withdrawal rollers faster than the feed rate of the feed rollers; a rolling, which comprises interposing a sheet between a pair of rollers facing each other, rolling the sheet using the rollers; and others.

The forming process of the prism portion may include conventional processes. For example, as described in Examples of Japanese Patent No. 3607759 publication, the prism portion can be produced by hot-pressing a mold having a prismatic shape (for example, a mold having a number of prisms, each having an isosceles triangular cross-section, formed in a row so as to be parallel in each top edge line) against a sheet prepared by the above-mentioned process (a sheet once cooled for solidification by the above-mentioned process) and cooling the resulting product for solidification.

Another process may include, for example, as described in Japanese Patent No. 2925069 publication, a process which comprises melt-extruding a diffusive semitransparent material on a continuous mold-releasing sheet having a solid pattern to transfer the solid pattern to the surface of the extruded material and cooling the material for solidification.

In these forming process of the prism portion, when the prism portion forms a prism array and the dispersed phase has a modified shape, optical sheets with different orientations of the longitudinal direction of the dispersed phase may be produced by forming the prism array so as to make the oriented direction of the dispersed phase parallel or perpendicular to the axial (or longitudinal) direction of the prism units (for example, in a process using a metal mold, by disposing the prism units in the metal mold so as to direct to a predetermined direction). For example, when the prism portion is formed so that the orientation direction of the dispersed phase is parallel to the axial (or longitudinal) direction of the prism units, an optical sheet shown in FIG. 8 can be obtained. When the prism portion is formed so that the orientation direction of the dispersed phase is perpendicular to the axial (or longitudinal) direction of the prism units, an optical sheet shown in FIG. 10 can be obtained.

[Plane Light Source Device]

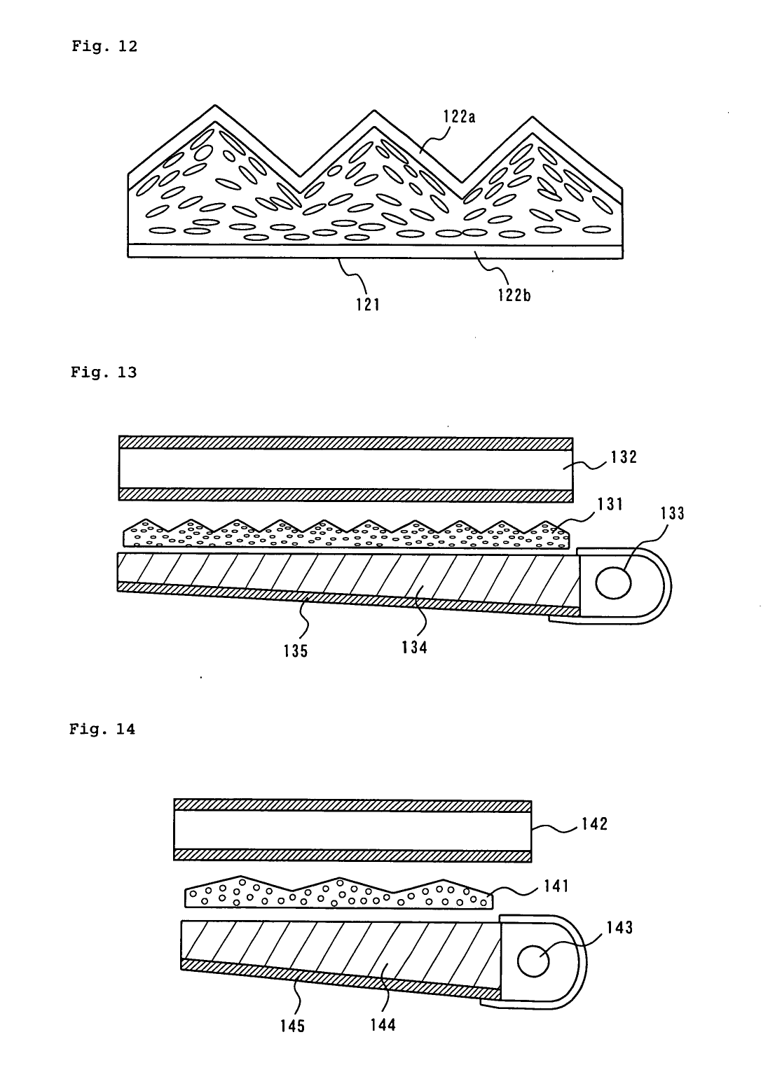

FIG. 13 is a schematic exploded sectional view of a display unit comprising a liquid crystal cell and a plane light source device using the optical sheet of the present invention. The plane light source device has an optical sheet 131, a light guide plate 134, a reflector 135 arranged in this order and a fluorescent tube 133 disposed in the side part of the conductive plate 134. In the plane light source device, a light is generated from the fluorescent tube 133, the generated light is conducted by the light guide plate 134, and the conducted light is emitted from the surface of the light guide plate 134. Part of the light generated from the fluorescent tube 133 is reflected from the reflector 135 and emitted from the surface of the light guide plate 134. The outgoing light is diffused by the optical sheet 131 so that the diffused light is condensed, whereby the device shows the effects as a plane light source device. That is, the condensed light enters a liquid crystal cell 132, which is a display unit, and the liquid crystal cell 132 serves as a display part for a liquid crystal display apparatus.

Such a plane light source device comprising the optical sheet of the present invention can generate neither bright line nor dark line or at least reduce the generation of the line to an extremely small amount. Further, single use of the optical sheet of the present invention can inhibit the bright line or the dark line and improve the luminance. Furthermore, according to the present invention, since it is unnecessary to use two sheets, that is, a diffusion sheet and a prism sheet, the plane light source device can be easily assembled and has no shortcoming that foreign substances are present between these two sheets.

FIG. 14 is a schematic exploded sectional view illustrating an example of a plane light source device using the optical sheet shown in FIG. 8. In the optical sheet 141, the major-axis direction of the light-scattering phase (dispersed phase) is approximately parallel to the axial (or longitudinal) direction of the prism units. Also in the plane light source device, a light is generated from a fluorescent tube 143, the generated light is conducted by a light guide plate 144, and the conducted light is emitted from the surface of a light guide plate 144. Part of the light generated from the fluorescent tube 143 is reflected from a reflector 145 and emitted from the surface of the light guide plate 144. The outgoing light is diffused by the optical sheet 141 of the present invention so that the diffused light is condensed, whereby the device shows the effects as a plane light source device. That is, the condensed light enters a liquid crystal cell 142, which is a display unit, and the liquid crystal cell 142 serves as a display part for a liquid crystal display apparatus. Single use of such an optical sheet can also inhibit the bright line or the dark line and improve the luminance. Incidentally, the light-condensing effect can be achieved by selecting the angle of the vertex angle and the concentration of the rugby ball-shaped dispersed phase suitably. The plane light source device comprising the optical sheet has an improved luminance due to a higher light-condensing effect compared with a plane light source device comprising an optical sheet having an isotropically scattering function.

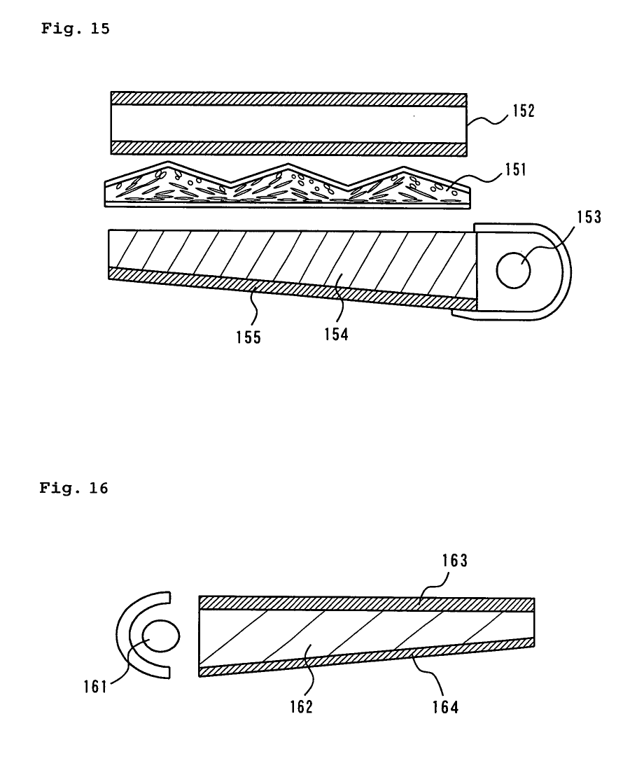

FIG. 15 is a schematic exploded sectional view of a plane light source device using the optical sheet shown in FIG. 12. In an optical sheet 151, the major-axis direction of the dispersed phase is approximately perpendicular to the axial (or longitudinal) direction of the prism units. Also in the plane light source device, a light is generated from a fluorescent tube 153, the generated light is conducted by a light guide plate 154, and the conducted light is emitted from the surface of the light guide plate 154. Part of the light generated from the fluorescent tube 153 is reflected from a reflector 155 and emitted from the surface of the light guide plate 154. The outgoing light is diffused by the optical sheet 151 of the present invention so that the diffused light is condensed, whereby the device shows the effects as a plane light source device. That is, the condensed light enters a liquid crystal cell 152, and the liquid crystal cell 152 serves as a display part for a liquid crystal display apparatus. Single use of such an optical sheet can also inhibit the bright line or the dark line and improve the luminance. Further, the plane light source device comprising the optical sheet has a further improved luminance compared with a plane light source device comprising the optical sheet shown in FIG. 8.

In the plane light source device of the present invention, a common transparent prism sheet possibly improves the luminance by making the prism array (or portion) of the common sheet perpendicular or parallel to that of the optical sheet of the present invention. Even in this case, the number of sheets to be disposed on the light guide plate is only two.

The plane light source device of the present invention may further comprise at least one member selected from the group consisting of a diffusion sheet, a polarization-transforming brightness enhancement sheet, and a view control sheet. These sheets may be disposed on the optical sheet or between the optical sheet and the light guide plate.

According to the present invention, a specific prism portion constituting part of a sheet comprising a dispersed phase and a transparent continuous phase can inhibit a bright line or a dark line in a plane light source device to be used for a liquid crystal display apparatus or the like and improve the luminance. Further, use of the optical film can inhibit an interference pattern which is caused by a laminated structure of a diffusion sheet and a prism.

The optical sheet of the present invention is useful as a part (or member) for a plane light source device. Further, a plane light source device comprising the optical sheet is useful for illuminating various display units or apparatuses, for example, a display apparatus or device such as a liquid crystal display (LCD), a cathode ray tube display, an organic or inorganic electroluminescence (EL) display, a field emission display (FED), a surface-conduction electron-emitter display (SED), a rear projection television display, a plasma display, or a touch panel-attached input device, particularly, a liquid crystal display.

### EXAMPLES

The following examples are intended to describe this invention in further detail and should by no means be interpreted as defining the scope of the invention. In the following examples, the formation and evaluation of the plane light source device, the evaluation of the bright line and dark line, the front luminance, and the widths of the front luminance and luminance distribution were measured and evaluated by the following methods.

(Formation and Evaluation of Plane Light Source Device)

In order to test the performance of the optical sheet of the present invention, the following plane light source apparatus and measuring machine were used. A commercially available 7-inch transmissive liquid crystal display apparatus (a lateral direction longer than a longitudinal direction, a horizontal installation type, a resolution of 1024×766/XGA, a contrast of 450:1, an electricity consumption of 33 W) was obtained. The display apparatus was dismantled, and a liquid crystal cell part was removed therefrom to confirm the construction of a plane light source device part. The plane light source device part had a light guide plate Lg, fluorescent tubes disposed in both lateral sides (along with the lateral direction) of the light guide plate Lg, respectively, and a white diffusive reflection sheet disposed on a first side of the light guide plate. On a second side of the light guide plate, a diffusion sheet D, a prism sheet P, and a polarization-transforming brightness enhancement sheet were laminated in this order. In the plane light source device having such a formation, the optical sheet Pd of the present invention was used instead of the existing prism sheet P and diffusion sheet D in Examples. Moreover, a commercial prism sheet P1 and/or a newly made diffusion sheet D1 were/was used instead of the existing prism sheet P and diffusion sheet D in Comparative Examples.

(Measurement of Luminance Distribution, and Evaluation of Bright Line and Dark Line)

The luminance distribution was measured by placing the plane light source device on a rotating table, turning on the power of the plane light source to illuminate the display, and rotating the plane light source device. The measurement was conducted at distance of 30 cm to the plane light source by using a luminance meter (manufactured by Minolta Co., Ltd., MINOLTA SPECTROMETAR CS-1000). The diffusion sheet D, the prism sheet P, and the polarization-transforming brightness enhancement sheet were removed from the above-mentioned plane light source device. In place of these sheets, the optical sheet of the present invention was disposed on the light guide plate for the measurement of Examples, and the prism sheet P1 and/or the diffusion sheet D1 were/was disposed on the light guide plate for the measurement of Comparative Examples. Further, a bright line and a dark line were visually observed and evaluated on the basis of the following criteria.

A: The bright line and the dark line are completely invisible.

B: The bright line and the dark line slightly appear and are not completely invisible.

C: The bright line and the dark line appear, and the unit is not suitable for practical use even if other sheets are additionally used.

(Front Luminance and Width of Luminance Distribution)

For the measurement of the front luminance and the width of the luminance distribution, a plane light source device in which the existing diffusion sheet and upper prism sheet (having grooves arranged in lines to a lateral direction thereof and condensing a light of a longitudinal direction thereof) were disposed on a light guide plate (a plane light source device, which was meant to be Comparative Example 1) was used. The lamp of the unit was turned on, and a front luminance obtained by a luminance distribution measurement, and a width of a luminance distribution in a position at which the luminance was reduced by one-third relative to the front luminance in the longitudinal and lateral directions were defined as reference values, respectively. The front luminance was represented as a ratio, and the width of the luminance distribution was represented as a difference thereof.

### Example 1

### Production of Optical Sheet

The following components were used as raw materials for a semitransparent light-diffusion material: 95 parts by weight of a crystalline polypropylene-series resin PP (manufactured by Grand Polymer Co., F133, refractive index: 1.503) as a transparent resin, 4.75 parts by weight of a polystyrenic resin GPPS (a general-purpose polystyrenic resin, manufactured by Daicel Chemical Industries, Ltd., GPPSHRM10N, refractive index: 1.589) as a dispersed phase resin, and 0.25 part by weight of an epoxidized diene-series block copolymer resin (manufactured by Daicel Chemical Industries, Ltd., EPOFRIEND AT202; styrene/butadiene=70/30 (weight ratio), epoxy equivalent: 750, refractive index: 1.57) as a compatibilizer.

The above-mentioned raw materials were dried at 70° C. for about 4 hours, respectively, and kneaded in a Banbury mixer. Using a single-layer extruder, the resulting mixture was melted at about 220° C. and extruded from a T-die with a draw ratio of about 3 onto a cooling or chilling drum having a surface temperature of 60° C. to obtain a sheet having a thickness of 120 μm and a diffusive anisotropy.

Observation of the cross-section along with the take-up direction of the sheet with an optical microscope revealed that the dispersed phase was dispersed in a rugby ball-like shape (having an aspect ratio of about 8, a mean major axis of about 8 μm, and a mean minor axis of about 1 μM).

The anisotropic light-scattering property of the sheet was shown as Fy(18°)/Fx(18°)≈12. Moreover, the haze was 70%, and the total light transmittance was 90%, provided that, the term Fy(18°) means a scattering intensity in a direction perpendicular to the take-up direction (that is, the minor-axis direction of the rugby ball-like shape) at a scattering angle θ of 18° and the term Fx(18°) means a scattering intensity in a direction parallel to the take-up direction (that is, the major-axis direction of the rugby ball-like shape) at a scattering angle θ of 18°.

(Formation of Prism Portion)

A metal mold having a number of prisms formed in a row was provided. Each of the prisms had an isosceles triangular cross-section of which the vertex angle was 85° and the height was 25 μm, and these prisms were parallel in each top edge line. The produced sheet having a thickness of 120 μm and a diffusive anisotropy was placed on a metal plate having an approximately flat surface and attached to a heat press together with the metal mold. The sheet was pre-heated at a mold temperature of 200° C. for 15 minutes and then pressed at a pressure of 100 kg/cm² (9.8 MPa), and the pressure was maintained for 15 minutes. Thereafter, the sheet was cooled to an atmospheric temperature to give an optical sheet. The heat pressing was performed by bringing the top edge lines of the prisms of the metal mold into approximately line with a take-up direction of the sheet having a thickness of 100 μm and a diffusive anisotropy.

Observation of the cross-section parallel to the top edge line directions of the prism units with an optical microscope revealed that the dispersed phase recognized in the sheet having a diffusive anisotropy (the dispersed phase having a rugby ball-like shape (having an aspect ratio of about 8, a mean major axis of about 8 μm, and a mean minor axis of about 1 μm)) was also present in the optical sheet.

The obtained optical sheet was disposed on the light guide plate of the above-mentioned dismantled plane light source apparatus, and the lamp was turned on to measure a luminance distribution. The bright line and dark line were visually observed, provided that a direction parallel to the top edge lines of the prism units of the optical sheet corresponded to the lateral direction of the plane light source device. The observation of the bright line and the dark line and the evaluation results of the front luminance and the width of the luminance distribution are shown in Table 1.

### Example 2

In the same manner as Example 1, a sheet having a diffusive anisotropy was produced and heat-pressed, provided that the heat-pressing was performed by making the top edge lines of the prisms of the metal mold approximately perpendicular to the take-up direction of the sheet having a thickness of 100 μm and a diffusive anisotropy. The obtained optical sheet was disposed on the light guide plate of the above-mentioned dismantled plane light source apparatus, and the lamp was turned on to measure a luminance distribution. The bright line and dark line were visually observed, provided that a direction parallel to the top edge lines of the prism units of the optical sheet corresponded to the lateral direction of the plane light source device. The observation of the bright line and the dark line and the evaluation results of the front luminance and the width of the luminance distribution are shown in Table 1.

### Comparative Example 1

### Production of Diffusion Sheet

A coating solution for a light diffusion sheet was prepared by adding 26 parts by weight of ethanol to 10 parts by weight of acrylic resin beads (a cross-linked polymethyl methacrylate particle, mean particle size: 30 μm) and 64 parts by weight of an acrylic resin emulsion (manufactured by Daicel Chemical Industries, Ltd., CEVIAN 4635). The coating solution was coated on a first surface of a polyester sheet (a polyethylene terephthalate sheet, transparent, no surface treatment, thickness: 16 μm) in an amount of 6 g/m², dried at 130° C. for 2 minutes to give a diffusion sheet.

The produced diffusion sheet and a commercially available prism sheet were disposed on the light guide plate of the above-mentioned dismantled plane light source, and the lamp was turned on to measure a luminance distribution. Incidentally, the commercially available prism sheet had prisms in a row, each having an isosceles triangular cross-section having a vertex angle of 90° and a base of 50 μm, and the prism sheet had a thickness of 100 μm and grooves arranged to a lateral direction thereof and condensed a light to the thickness direction thereof. The bright line and dark line were visually observed. The observation of the bright line and the dark line and the evaluation results of the front luminance and the width of the luminance distribution are shown in Table 1.

### Example 3

The raw materials for a semitransparent light-diffusion material of Example 1 and the crystalline polypropylene-series resin PP as a transparent resin for surface layers were used. The raw materials and the transparent layer resin component were dried at 70° C. for about 4 hours, respectively, and kneaded in a Banbury mixer. Using a multi-layer extruder, the raw materials and the transparent layer resin component as surface layers were melted at about 220° C. and extruded from a T-die with a draw ratio of about 3 onto a cooling or chilling drum having a surface temperature of 60° C. to give a three-layered sheet (thickness: 180 μm) comprising two kinds materials. The sheet had a central layer having a thickness of 90 μm (a layer comprising the diffusive transparent material) and two surface layers (transparent resin layers) laminated on both surfaces thereof, respectively, each having a thickness of 30 μm, that is, a three-layered sheet comprising a transparent layer, a light diffusion layer, and a transparent layer in this order.

Observation of the central layer with an optical microscope revealed that in the central layer the dispersed phase had a rugby ball-like shape (having an aspect ratio of about 7, a mean major axis of about 7 μm, and a mean minor axis of about 1 μm) and dispersed.

The anisotropic light-scattering property of the sheet was shown as Fy(18°)/Fx(18°)≈10. Moreover, the haze was 60%, and the total light transmittance was 90%.

In the same manner as Example 1, the sheet was heat-pressed, provided that the heat-pressing was performed by making the top edge lines of the prisms of the metal mold approximately perpendicular to the take-up direction of the three-layered sheet comprising two kinds materials and having a diffusion anisotropy.

The obtained optical sheet was disposed on the light guide plate of the above-mentioned dismantled plane light source apparatus, and the lamp was turned on to measure a luminance distribution. The bright line and dark line were visually observed, provided that a direction parallel to the top edge lines of the prism units of the optical sheet corresponded to the lateral direction of the plane light source device. The observation of the bright line and the dark line and the evaluation results of the front luminance and the width of the luminance distribution are shown in Table 1.

### Comparative Example 2

The commercially available prism sheet used in Comparative Example 1 was disposed alone on the light guide plate of the above-mentioned dismantled plane light source apparatus, and the lamp was turned on to measure a luminance distribution. The bright line and dark line were visually observed. The observation of the bright line and the dark line and the evaluation results of the front luminance and the width of the luminance distribution are shown in Table 1.

### Comparative Example 3

The diffusion sheet obtained in Comparative Example 1 was disposed alone on the light guide plate of the above-mentioned dismantled plane light source apparatus, and the lamp was turned on to measure a luminance distribution. The bright line and dark line were visually observed. The observation of the bright line and the dark line and the evaluation results of the front luminance and the width of the luminance distribution are shown in Table 1.

### Example 4

In the same manner as Example 2 except that the vertex angle of the isosceles triangle of the metal mold was 75°, a sheet having a diffusive anisotropy was produced and heat-pressed. The evaluation results of the obtained sheet are shown in Table 1.

### Example 5

In the same manner as Example 2 except that the vertex angle of the isosceles triangle of the metal mold was 100°, a sheet having a diffusive anisotropy was produced and heat-pressed. The evaluation results of the obtained sheet are shown in Table 1.

Incidentally, abbreviations used in Table 1 are shown as follows.

Lg: Light guide plate

Pd: Optical sheet of the present invention

P1: Prism sheet

D1: Diffusion sheet

Width 1 (lateral direction): Direction in which a plurality of isosceles triangular prisms were disposed side by side

Width 2 (longitudinal direction): Light-condensing direction of prism

TABLE 1

| | Example | Example | Comparative | Example | Comparative | Comparative | Example | Example |
|---|---|---|---|---|---|---|---|---|
| | 1 | 2 | Example 1 | 3 | Example 2 | Example 3 | 4 | 5 |
| Construction | Lg/Pd | Lg/Pd | Lg/P1/D1 | Lg/Pd | Lg/P1 | Lg/D1 | Lg/Pd | Lg/Pd |
| Number of | 1 | 1 | 2 | 1 | 1 | 1 | 1 | 1 |
| sheets | | | | | | | | |
| Evaluation | A | A | A | A | C | A | A | A |
| of bright line | | | | | | | | |
| and dark line | | | | | | | | |
| Front | 0.85 | 0.9 | 1 | 0.9 | 0.8 | 0.4 | 0.95 | 0.8 |
| luminance | | | | | | | | |
| Width 1 | +3° | +2° | Reference | +2° | +2° | No light- | +1° | +4° |
| (lateral | | | width | | | condensing | | |
| direction) | | | | | | effect | | |
| Width 2 | +4° | +2° | Reference | +2° | +2° | No light- | +1° | +5° |
| (longitudinal | | | width | | | condensing | | |
| direction) | | | | | | effect | | |

As apparent from the results shown in Table 1, the optical sheet of the present invention realizes the luminance enhancement and the invisibility of the bright line and dark line by only one sheet, which has been conventionally achieved by using a combination of two kinds sheets. The adjustment of the vertex angle of the prism achieves the luminance enhancement, which a conventional optical sheet affords. In addition, the optical sheet of the present invention inhibits a useless wide-angle light leakage and ensures broader width of the luminance distribution.

What is claimed is:

1. An optical sheet comprising
a continuous phase comprising a transparent material and
a dispersed phase dispersed in the continuous phase, and
having a first surface and a second surface,
at least one of the first surface and the second surface forming a prismatic surface of a prism portion constituting portion of the sheet, the prism portion having a plurality of prism units formed regularly in a longitudinal and/or width direction of the sheet, and each prism unit having a triangular cross-section.

2. An optical sheet according to claim 1, wherein the prism units are formed in parallel with each other and form a prism array.

3. An optical sheet according to claim 1, wherein each of the prism units has an isosceles triangular cross-section with a vertex angle of 60 to 120°.

4. An optical sheet according to claim 1, wherein the prism units have a pitch of 10 to 1000 μm, and the thickness of the sheet is 30 to 3000 μm including a height of the prism unit.

5. An optical sheet according to claim 1, wherein the continuous phase comprises a first transparent thermoplastic resin, and the dispersed phase comprises a second thermoplastic resin having a different refractive index from that of the first thermoplastic resin.

6. An optical sheet according to claim 1, wherein the dispersed phase has a modified shape being a mean aspect ratio of larger than 1.

7. An optical sheet according to claim 6, wherein the mean length of the minor axis of the dispersed phase is 0.1 to 10 μm, and the mean aspect ratio of the dispersed phase is 1.1 to 1000.

8. An optical sheet according to claim 6, wherein the prism units are formed in parallel with each other and form a prism array, and
the major-axis direction of the dispersed phase is approximately parallel to the axial direction of the prism units.

9. An optical sheet according to claim 6, which further comprises a flat base portion,
wherein the prism portion protrudes from the base portion, the prism units are formed in parallel with each other and form a prism array, and
the major-axis direction of the dispersed phase is approximately perpendicular to the axial direction of the prism units, and
in the prism portion the major-axis direction of the dispersed phase is approximately parallel to the prismatic surface of the prism portion, and in the base portion the major-axis direction of the dispersed phase is approximately parallel to a planar surface of the base portion.

10. An optical sheet according to claim 1, wherein the absolute difference in refractive index between the continuous phase and the dispersed phase is not less than 0.001.

11. An optical sheet according to claim 1, wherein the weight ratio of the continuous phase relative to the dispersed phase is 99.9/0.1 to 30/70.

12. An optical sheet according to claim 1, wherein at least one of the first and second surfaces has a transparent resin layer formed thereon.

13. An optical sheet according to claim 12, wherein the mean thickness ratio of the transparent resin layer is 1 to 50% of the whole thickness of the sheet.

14. A plane light source device comprising
a light source,
a light guide plate,
a reflection means, and
a first optical sheet recited in claim 1,
wherein the first optical sheet is disposed adjacent to a first surface of the light guide plate, and the reflection means is disposed adjacent to a second surface of the light guide plate.

15. A plane light source device according to claim 14, which further comprises a second optical sheet,
wherein in the first optical sheet, the prism units are formed in parallel with each other and forms a prism array, the second optical sheet has a prism portion having a plurality of prism units formed in parallel with each other and forming a prism array, the first and second optical sheets are disposed so that the axial directions of the prism units of the first and second optical sheets are perpendicular to each other, and at least one of the first and second optical sheets is a sheet recited in claim 2.

16. A plane light source device according to claim 14, which further comprises at least one member selected from the group consisting of a diffusion sheet, a polarization-transforming brightness enhancement sheet, and a view control sheet.
